(19) United States
(12) Patent Application Publication
(10) Pub. No.: US 2011/0289987 A1
(43) Pub. Date: Dec. 1, 2011

(54) DOOR LOCK ASSEMBLY HAVING PUSH/PULL HANDLES

(75) Inventors: Ming-Shyang CHIOU, Chiayi City (TW); Yu-Le LIN, Yunlin County (TW); Kuang-I LIAO, Tainan City (TW)

(73) Assignee: TONG LUNG METAL INDUSTRY CO., LTD., Chia-Yi City (TW)

(21) Appl. No.: 13/115,526

(22) Filed: May 25, 2011

(30) Foreign Application Priority Data
May 26, 2010 (TW) 099209935
May 26, 2010 (TW) 099209936

(51) Int. Cl. E05B 65/00; E05C 1/10

(52) U.S. Cl. 70/91; 292/140

(57) ABSTRACT

In a door lock assembly, a push/pull handle is connected to a slide plate through an actuator. When the handle is operated, the actuator drives a rotary cam to rotate a spindle tube, which in turn operates a latch cam connected to a latch. The slide plate is mounted movably within a housing in proximity to the rotary cam to slide transversely of a rotation axis of the spindle tube, and has two drive elements to respectively drive two driven elements of the rotary cam. The actuator is formed as a strip having one end connected to the handle, and another end connected to the slide plate. The strip is pivotal along with the handle to actuate the slide plate.

### CROSS-REFERENCE TO RELATED APPLICATION

This application claims priority of Taiwanese Patent Application Nos. 099209935 filed on May 26, 2010 and 099209936 filed on May 26, 2010.

### BACKGROUND OF THE INVENTION

1. Field of the Invention

The invention relates to a door lock assembly, and, more particularly, to a push/pull type door lock assembly that can be operated by pushing or pulling a lever handle.

2. Description of the Related Art

Push/pull type door lock assemblies have existed in various forms in the prior art. Examples of such door lock assemblies are disclosed in U.S. Patent Application Nos. 20090282880, 20060214436, 20060261608, and U.S. Pat. Nos. 7,258,374, 6,196,599, Re36209, 5,730,478, 4,629,228, and 4,192,536.

### SUMMARY OF THE INVENTION

An object of the present invention is to provide an improved push/pull type door lock assembly that has a simple construction compared to the prior art.

According to one aspect of the invention, a door lock assembly comprises: an inner housing; a rotary cam mounted rotatably within an inner housing and having two angularly spaced apart driven elements; a spindle tube extending through and rotating along with the rotary cam about a rotation axis; an inner handle connected movably to the inner housing to pivot about a pivot axis transverse to the rotation axis; a slide plate mounted movably within the inner housing in proximity to the rotary cam to slide transversely of the rotation axis, and having two drive elements to respectively drive the driven elements; an actuator having one end connected to the inner handle, and another end connected to the slide plate, the actuator being moved by the inner handle to actuate a sliding movement of the slide plate; and a latch unit connected to and driven by the spindle tube to move to a retracted position from an extended position when one of the driven elements is driven by one of the drive elements.

According to another aspect of the invention, a door lock assembly comprises: an outer housing; a rotary cam mounted rotatably within the outer housing and having two angularly spaced apart driven elements; a spindle tube extending through and rotating along with the rotary cam about a rotation axis; an outer handle connected movably to the outer housing to pivot about a pivot axis transverse to the rotation axis; a slide plate mounted movably within the outer housing in proximity to the rotary cam to slide transversely of the rotation axis, and having two drive elements to respectively drive the driven elements; an actuator having one end connected to the outer handle, and another end connected to the slide plate, the actuator being moved by the outer handle to actuate a sliding movement of the slide plate; a latch unit connected to and driven by the spindle tube to move from an extended position to a retracted position; a key-operated lock disposed S within the outer housing and having a plug; a transmission shaft connected to the plug and extending through the rotary cam and the spindle tube; and a limit plate having a passage hole for passage of the transmission shaft, and disposed adjacent the slide plate to prevent the slide plate from moving when the key-operated lock is in a locking position.

According to still another aspect of the invention, a door lock assembly comprises: a latch unit including a latch housing, and a latch disposed in the latch housing and movable between an extended position and a retracted position, the latch housing having a pair of latch mounting holes; an outer lock unit to operate the latch unit, including an outer housing, and an outer cover plate to cover the outer housing, the outer cover plate incorporating a pair of spaced apart first mounting posts and a pair of spaced apart second mounting posts; and an outer handle connected pivotally to the outer housing, wherein the outer handle is placed in a first position when the first mounting posts extend respectively through. the latch mounting holes, and in a second position when the second mounting posts extend respectively through the latch mounting holes, and the first and second positions are distant from each other by a predetermined angle.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded view of a door lock assembly according to a preferred embodiment of the present invention;

FIG. 2 is an exploded view of an inner lock unit of the door lock assembly;

FIG. 3 is an exploded view of an outer lock unit of the door lock assembly;

FIG. 4 is a sectional view of the door lock assembly in an unlocking position;

FIG. 5 is a plan view of the outer lock unit before an outer cover plate is attached;

FIG. 6 is a plan view of the inner lock unit before an inner cover plate is attached;

FIG. 7 is the same view as FIG. 4 but showing that an inner handle is pushed;

FIG. 8 is the same view as FIG. 6 but showing that a slide plate of the inner lock unit slides upward;

FIG. 9 is the same view as FIG. 4 but showing that the inner handle is pulled;

FIG. 10 is the same view as FIG. 6 but showing that a slide plate of the inner lock unit slides downward;

FIG. 11 is the same view as FIG. 5 but showing that a slide plate of the outer lock unit slides upward;

FIG. 12 is the same view as FIG. 5 but showing that the slide plate of the outer lock unit slides downward;

FIG. 13 is the same view as FIG. 5 but showing that a limit plate of the outer lock unit engages the slide plate; and

FIG. 14 is the same view as FIG. 6 but showing that an end piece of a turning knob of the inner lock unit engages the slide plate.

### DETAILED DESCRIPTION OF THE PREFERRED EMBODIMENTS

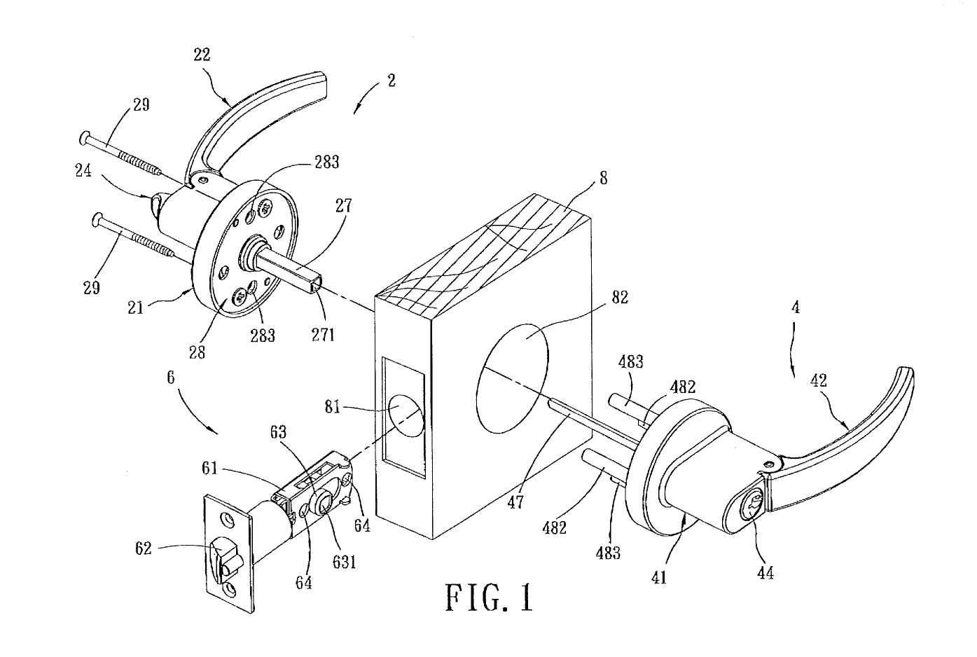

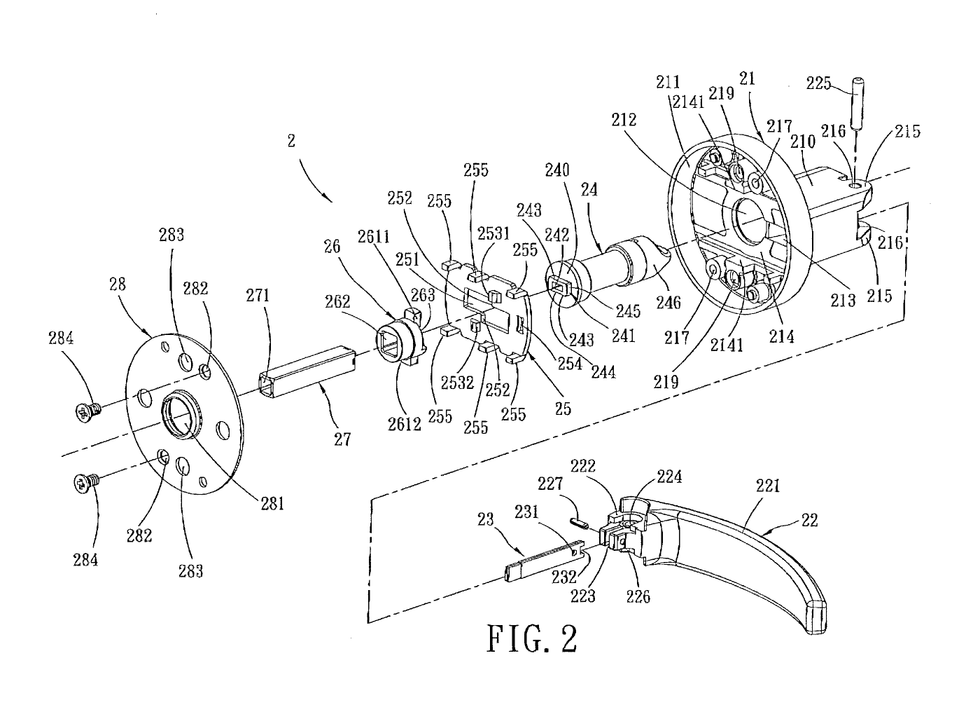

Referring to FIGS. 1 to 3, a push/pull lock device according to a preferred embodiment of the present invention is mountable on a door panel 8, and includes an inner lock unit 2, an outer lock unit 4 and a latch unit 6.

The inner lock unit 2 includes an inner housing 21, an inner handle 22, an actuator 23, a turning knob 24, a slide plate 25, a rotary cam 26, a spindle tube 27, and an inner cover plate 28.

The inner housing 21 includes a cap portion 211, and an extension portion 210 protruding from an outer side of the cap portion 211. The cap portion 211 has a slide channel 214 formed on an inner surface of the cap portion 211, two screw holes 217, and two mounting post connecting holes 219. The slide channel 214 is defined by two ribs 2141. The extension portion 210 has first and second receiving spaces 212, 213 and two spaced apart lugs 215 formed with aligned pivot holes 216.

The inner handle 22 has a push/pull type lever arm 221, a pivot part 222, a first pivot hole 224, a second pivot hole 226 and a groove 223. The groove 223 is in spatial communication with the second pivot hole 226. A protrusion (not shown) is formed within the groove 223. The inner handle 22 is connected to the extension portion 210 by inserting a pin 225 through the pivot holes 216 of the extension portion 210 and the first pivot hole 224 of the inner handle 22.

The actuator 23 is disposed within the second receiving space 213 of the extension portion 210, and is configured to be a strip, which may be rigid or resiliently flexible. The actuator 23 has one end connected to the inner handle 22 and another end connected to the slide plate 25. The end of the actuator 23 connected to the inner handle 22 has a pivot slot 231 and a notched edge 232, and is pivoted to the pivot part 222 of the inner handle 22 by inserting the notched edge 232 into the groove 223 and by inserting a pivot pin 227 through the second pivot holes 226 and the groove 223 of the inner handle 22 and the pivot hole 231 of the strip of the actuator 23. The second pivot holes 226 and the pivot hole 231 are aligned with each other when the notched edge 232 receives the protrusion (not shown) in the groove 223. When the inner handle 22 is pushed or pulled, another end of the actuator 23 rotates a limited angle about a pivot axis of the pivot part 222 of the inner handle 22. A rotating angle of the actuator 23 is limited by a wall confining the second receiving space 213 of the extension portion 210.

The spindle tube 27 has a rectangular cross section and is inserted into a rectangular central hole 262 of the rotary cam 26. A rectangular through hole 271 is formed in the spindle tube 27. The spindle tube 27 and the rotary cam 26 are rotatable together about a rotation axis transverse to the pivot axis of the pivot pin 225.

The turning knob 24 is mounted within the first receiving space 212 of the extension portion 210, and includes an interior end that has an end face 240, and an end piece 241 protruding from the end face 240, and an operating outer end 246 exposed from the extension portion 210. The end piece 241 is centered at the rotation axis of the spindle tube 27 and is elongated in a diametric direction. The end piece 241 has an oblong central slot 242, two opposite long sides 244 in the diametric direction, two opposite short sides 245 interconnecting the long sides 244, and two opposite abutment surfaces 243. One of the abutment surfaces 243 is disposed on one of the long sides 244 adjacent to one of the short sides 245. The other one of the abutment surface 243 is disposed on the other one of the long sides 244 adjacent to the other one of the short sides 245.

The slide plate 25 is disposed slidably in the slide channel 214 within the cap portion 211, and includes S flanges 255 formed at two opposite sides of the slide plate 25 to contact slidably the ribs 2141 of the slide channel 214. The slide plate 25 further includes a middle hole 251, two drive elements 2537, 2532 projecting axially from the slide plate 25 on two opposite sides of the middle hole 251, and an engaging hole 254 spaced apart from the middle hole 251. The engaging hole 254 is used to insert the end of the strip of the actuator 23. When the inner handle 22 is pushed or pulled, the slide plate 25 can be moved by the actuator 23 in a sliding direction transverse to the rotation axis of the spindle tube 27. The middle hole 251 is elongated in the sliding direction and receives the end piece 241 formed at the interior end of the turning knob 24. The slide plate 25 further has an interaction member formed at an inner peripheral edge bounding the middle hole 251 to abut and interact with the abutment surfaces 243 of the end piece 241 for controlling rotation of the turning knob 24.

In this embodiment, the interaction member includes two opposite edge parts 252 of the inner peripheral edge bounding the middle hole 251. The edge parts 252 respectively abut the abutment surfaces 243 of the turning knob 24 when the door lock assembly is in a locking position (see FIG. 14). The end piece 241 and the turning knob 24 can be rotated when one of the edge parts 252 pushes one of the abutment surfaces 243.

The rotary cam 26 is disposed within the cap portion 211 adjacent the slide plate 25, and includes a rectangular central hole 262, two diametrically opposite driven elements 2611, 2612 that extend radially to be driven by the drive elements 2531, 2532 of the slide plate 25, respectively. When the slide plate 25 moves in one direction, the drive element 2531 drives the driven element 2611. When the slide plate 25 moves in an opposite direction, the drive element 2532 drives the driven element 2612. The rotary cam 26 is formed with two notches 263 (only one is shown) to avoid interference between the slide plate 25 and the rotary cam 26 when the drive element 2531 or 2532 drives the driven element 2611 or 2612.

The inner cover plate 28 has a central through hole 281, two angularly spaced apart screw holes 282, and two angularly spaced apart mounting post connecting holes 283. The inner cover plate 28 is fixed to the cap portion 211 to cover the slide plate 25 and the rotary cam 26. The rotary cam 26 extends through the central through hole 281, and the spindle tube 27 extends through the rotary cam 26. The screw holes 282 are aligned with the screw holes 217 of the cap portion 211 to attach screws 284 and to fasten the inner cover plate 28 to the cap portion 211. The mounting post connecting holes 283 of the inner cover plate 28 are aligned with the mounting post connecting holes 219 of the cap portion 211.

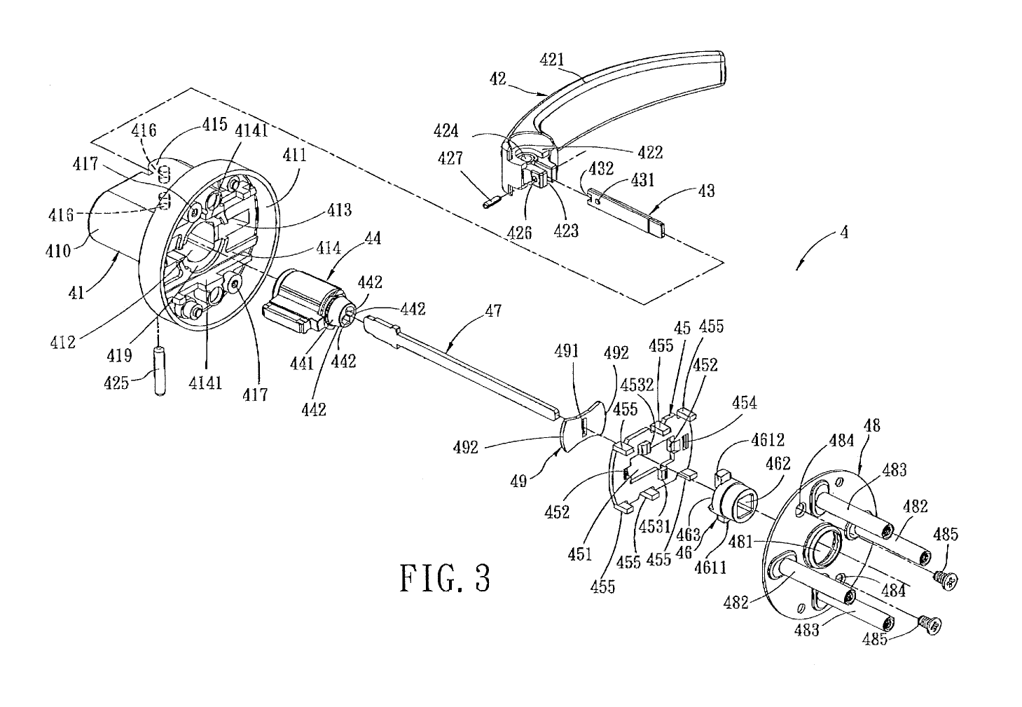

Referring to FIGS. 1 and 3, the outer lock unit 4 includes an outer housing 41, an outer handle 42, an actuator 43, a key-operated lock 44, a slide plate 45, a rotary cam 46, a transmission shaft 47, a limit plate 49, and an outer cover plate 48.

Like the inner housing 21, the outer housing 41 includes a cap portion 411, and an extension portion 410 protruding from an outer side of the cap portion 411. The cap portion 411 has a slide channel 414 formed on an inner surface of the cap portion 411, two screw holes 417, and a recess 419. The slide channel 414 is defined by two ribs 4141. The extension portion 410 has first and second receiving spaces 412, 413, and two spaced apart lugs 415 formed with aligned pivot holes 416.

Like the inner handle 22, the outer handle 42 has a push/pull type lever arm 421, a pivot part 422, a first pivot hole 424, a second pivot hole 426 and a groove 423. The groove 423 is in spatial communication with the second pivot hole 426. The outer handle 42 is connected to the extension portion 410 by inserting a pin 425 through the pivot holes 416 of the extension portion 410 and the first pivot hole 424 of the outer handle 42.

The actuator 43 is disposed in the second receiving space 413 of the extension portion 410, and is configured to be a strip which may be rigid or resiliently flexible. The actuator 43 has two ends respectively connected to the outer handle 42 and the slide plate 45. One end of the actuator 43 has a pivot slot 431 and a notched edge 432, and is pivoted to the pivot part 422 of the outer handle 42 by inserting the notched edge 432 into the groove 423 and by inserting a pivot pin 427 through the second pivot holes 426 and the groove 423 of the outer handle 42 and the pivot hole 431 of the actuator 43. When the outer handle 42 is pushed or pulled, the actuator 43 rotates together with the outer handle 42. A rotating angle of the actuator 43 is limited by a wall that confines the second receiving space 413.

The key-operated lock 44 is disposed in the first receiving space 412 of the extension portion 410, and has a plug 441 that has a tail end formed with four drive parts 442.

The transmission shaft 47 is flat and has one end disposed adjacent the drive parts 442 of the rotary plug 441 to be driven thereby. Another end of the transmission shaft 47 is inserted into the oblong central slot 242 of the end piece 241 of the turning knob 24. The transmission shaft 47 extends through the rotary cams 26, 46 and the spindle tube 27.

The limit plate 49 has two angularly spaced apart stop edges 492, and a passage hole 491 having a cross sectional shape similar to that of the transmission shaft 47. The transmission shaft 47 extends through the passage hole 491 so that the limit plate 49 can rotate when the transmission shaft 47 rotates. The stop edges 492 are used to abut the respective flanged parts 452 to limit the sliding movement of the slide plate 45 when the key-operated lock 44 is in a locking position.

The slide plate 45 is disposed slidably in the slide channel 414 within the cap portion 411, and includes flanges 455 formed at two opposite sides of the slide plate 45 to contact slidably the ribs 4141 of the slide channel 414. The slide plate 45 further includes a middle hole 451, an engaging hole 454 spaced apart from the middle hole 451, and two drive elements 4531, 4532 projecting axially from the slide plate 45 on two opposite sides of the middle hole 451. An inner peripheral edge bounding the middle hole 451 has two opposite flanged parts 452. The engaging hole 454 receives and engages the end of the strip of the actuator 43. When the outer handle 42 is pushed or pulled, the actuator 43 actuates the slide plate 45 to move in a transverse direction. The slide plate 45 is disposed adjacent one side of the limit plate 49, and the stop edges 492 of the limit plate 49 are used to abut against the flanged parts 452 of the slide plate 45 to limit movements of the slide plate 45.

The rotary cam 46 is disposed within the cap portion 411 adjacent the slide plate 45, and includes a central rectangular hole 462, and two angularly spaced apart driven elements 4611, 4612. The driven element 4611 is driven by the drive element 4531 of the slide plate 45 to rotate the rotary cam 46 in one direction. The driven element 4612 is driven by the drive element 4532 of the slide plate 45 to rotate the rotary cam 46 in an opposite direction. The rotary cam 46 further has two notches 463 (only one is shown) which are proximate to the driven elements 4611, 2612, respectively.

The outer cover plate 48 has a central hole 481, a pair of first mounting posts 482, a pair of second mounting posts 483, and a pair of screw holes 484. Each of the first mounting posts 482 is spaced apart angularly from one of the second mounting posts 483 by an angle of 90 degrees. The outer cover plate 48 covers the cap portion 411, and the rotary cam 46 is inserted into the central hole 481. The transmission shaft 47 extends through the central hole 481 of the outer cover plate 48, the passage hole 491 of the limit plate 49, and the central hole 462 of the rotary cam 46. The screw holes 484 are aligned respectively with the screw holes 417 of the cap portion 411 for extension of two screws 485 which fasten the outer cover plate 48 to the cap portion 411.

Referring back to FIG. 1, the latch unit 6 includes a latch housing 61 receiving a latch 62, and a latch cam 63 that has a rectangular cam hole 631. The latch housing 61 has two latch mounting holes 64.

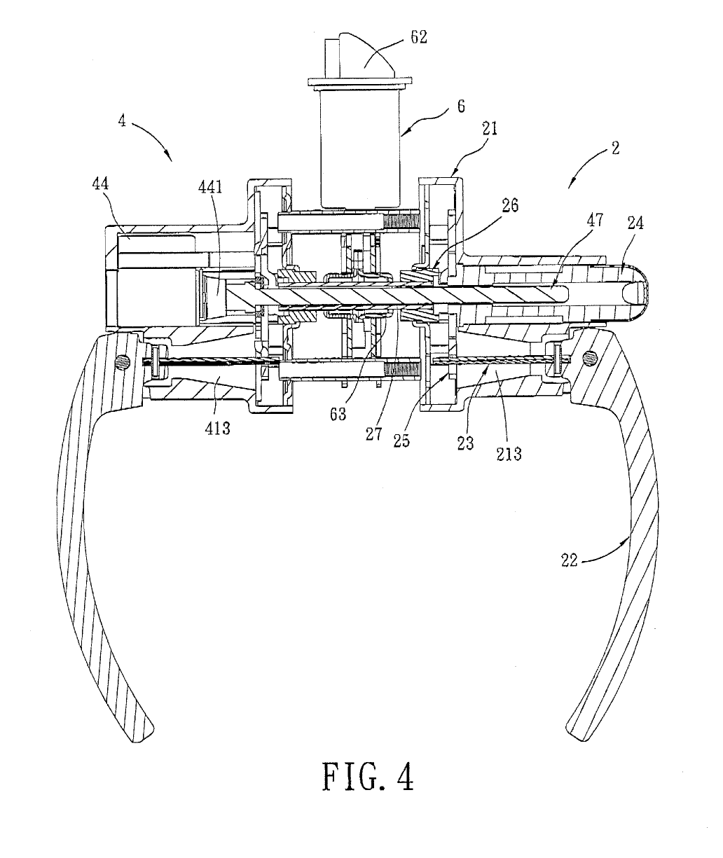

Referring to FIGS. 1 and 4, the latch unit 6 may be mounted inside a latch-mounting hole 81 of a door panel 8, and the inner and outer lock units 2 and 4 may be mounted to a lock hole 82 in the door panel 8. The inner and outer handles 22 and 42 may be placed in a first position (FIGS. 1 and 4) by aligning the first mounting posts 482 respectively with the latch mounting holes 64 of the latch unit 6, and in a second position (not shown) by aligning the second mounting posts 483 respectively with the latch mounting holes 64 of the latch unit 6. The inner and outer handles 22, 42 are pivotal about a vertical axis in the first position (FIG. 1). The first and second positions are distant from each other by an angle of substantially 90 degree.

To place the inner and outer handles 22, 42 in the first position (FIGS. 1 and 4), the first mounting posts 482 and the transmission shaft 47 are respectively passed through the latch mounting holes 64 and the rectangular cam hole 631. The spindle tube 27 is sleeved around the transmission shaft 47 and is passed through the rectangular cam hole 631. Two screw rods 29 are passed respectively through the mounting post connecting holes 219 in the cap portion 211 of the inner housing 21 and the mounting post connecting holes 283 in the inner cover plate 28 and are then fixed threadedly to the second mounting posts 483.

If the inner and outer handles 22, 42 are to be placed in the second position, the inner and outer housings 21, 41 may be rotated by 90 degrees to change the positions of the inner and outer handles 22, 42, the second mounting posts 483 may be passed through the latch mounting holes 64, and the screw rods 29 may be fixed threadedly to the second mounting posts 483.

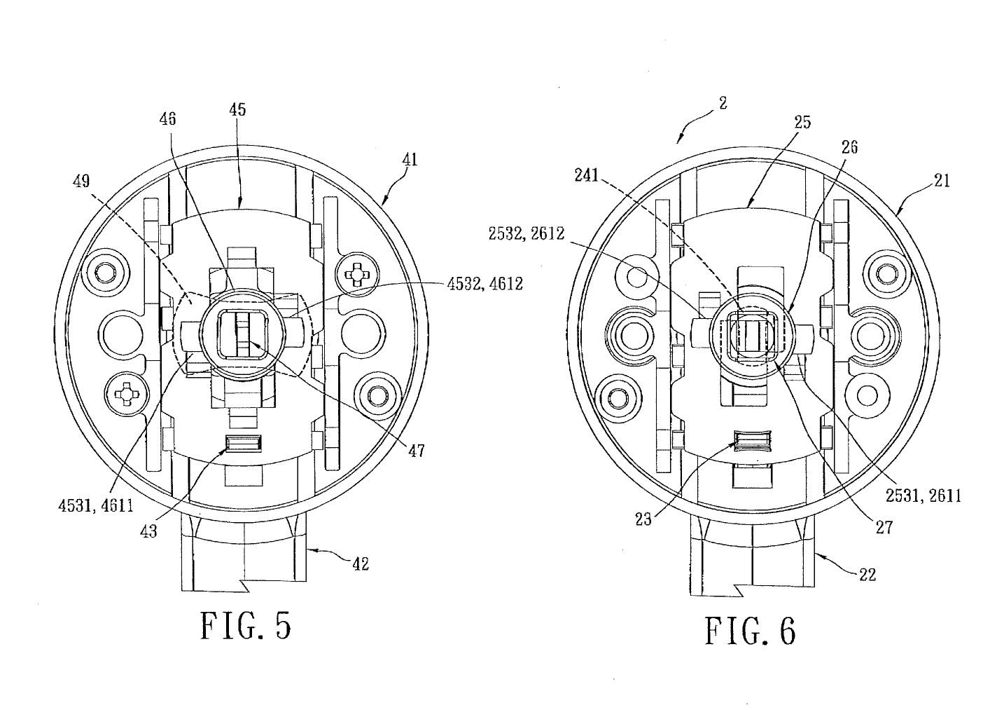

Referring to FIGS. 4-6, the door lock assembly of the present invention is in its unlocking state. The inner and outer handles 22, 42 are not pushed or pulled. The stop edges 492 of the limit plate 49 do not abut the flanged parts 452 of the slide plate 45. The abutment surfaces 243 of the turning knob 24 do not abut the edge parts 252 of the slide plate 25.

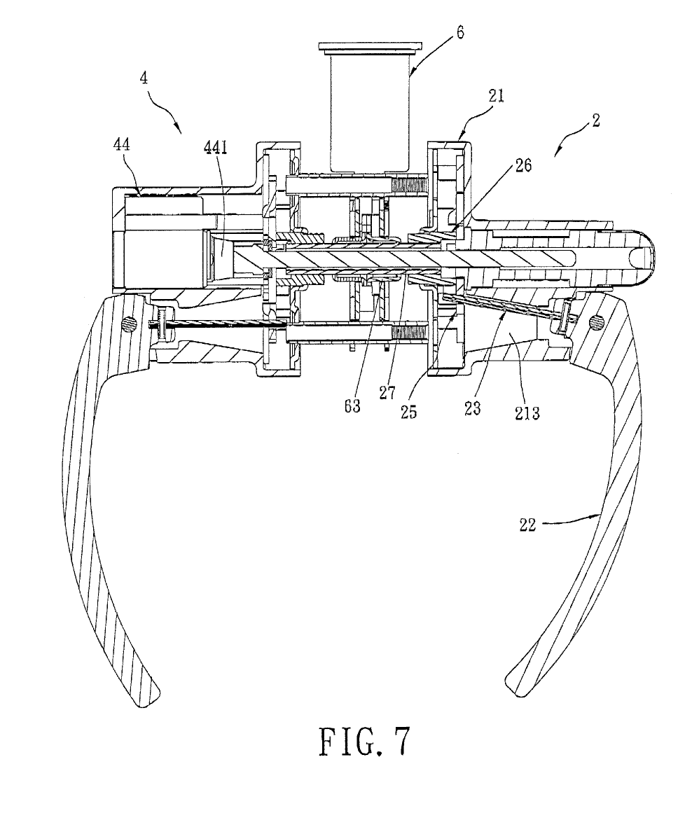

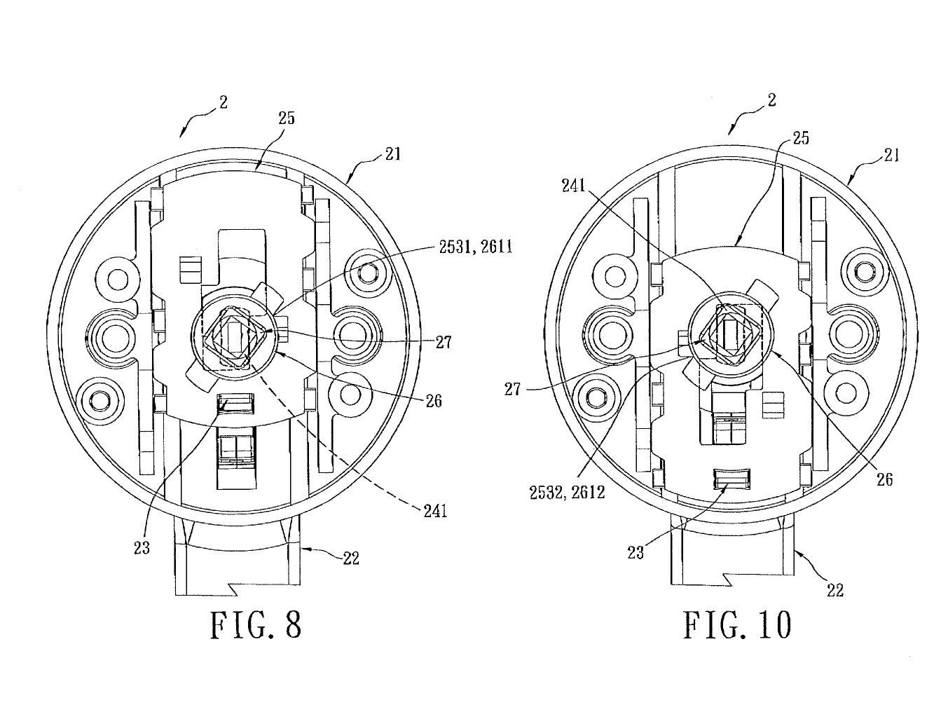

Referring to FIGS. 7 and 8, when the inner handle 22 is pushed or rotated about the pivot axis thereof to open a door, the strip of the actuator 23 is also rotated about the pivot axis of the inner handle 22. As the strip of the actuator 23 is rotated, the slide plate 25 slides upward, and the drive element 2531 pushes the driven element 2611 to rotate the rotary cam 26, driving rotation of the spindle tube 27. Accordingly, the latch cam 63 rotates and pulls the latch 62 to move to its retracted position.

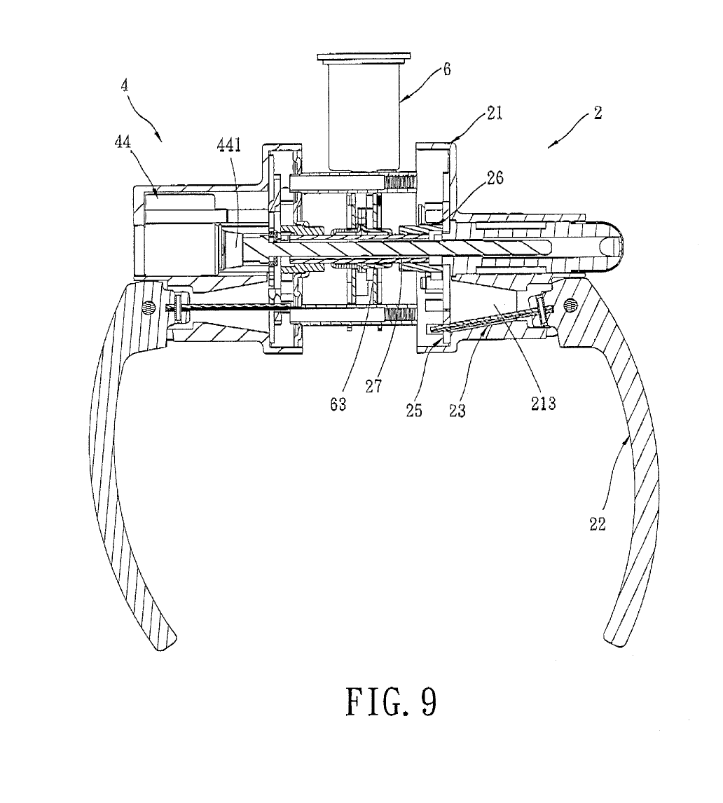

Referring to FIGS. 9 and 10, when the inner handle 22 is pulled or rotated to open a door, the actuator 23 can also be rotated about the pivot axis of the inner handle 22. However, the slide plate 25 will slide downward, and the drive element 2532 will push the driven element 2612 to rotate the rotary cam 26. Accordingly, the latch cam 63 will rotate and pull the latch 62 to move to its retracted position.

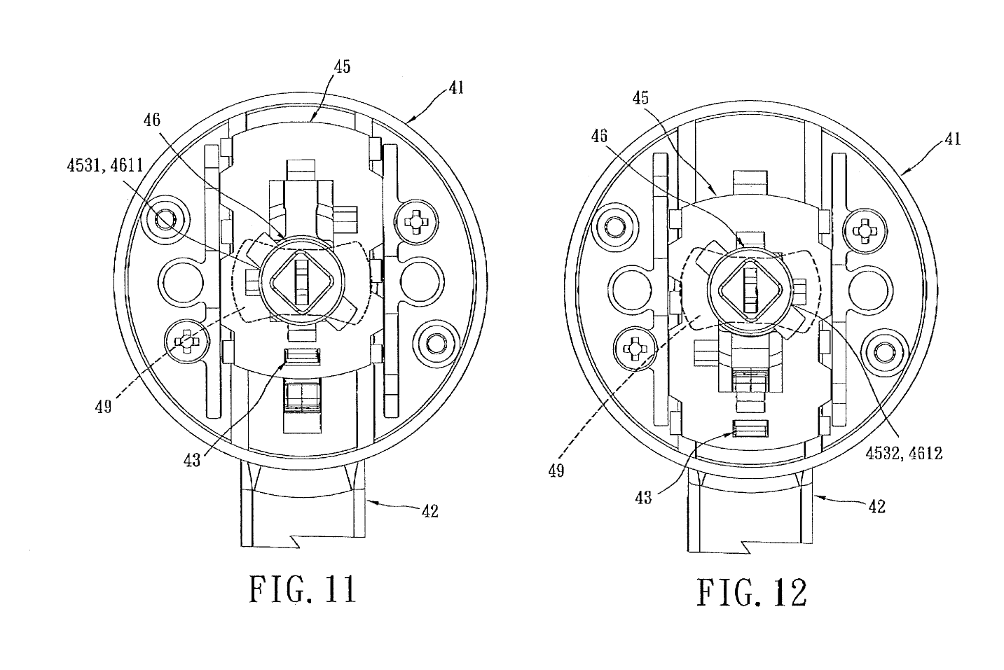

Similarly, when the outer handle 42 is pushed or pulled to open a door, the slide plate 45 can move upward or downward as shown in FIGS. 11 and 12.

Referring to FIGS. 1, 13 and 14, when the plug 441 of the key-operated lock 44 is operated using a key (not shown) to lock a door, or when the turning knob 24 is rotated to lock the door, the transmission shaft 47 is rotated, which in turn rotates the limit plate 49. As a result, the stop edges 492 of the limit plate 49 abut with the respective flanged parts 452 of the slide plate 45. Therefore, the slide plate 45 is prevented from movements and cannot be moved through a rotation (pushing/pulling) of the outer handle 42. At this state, the abutment surfaces 243 of the turning knob 24 are in abutment with the respective edge parts 252 of the slide plate 25.

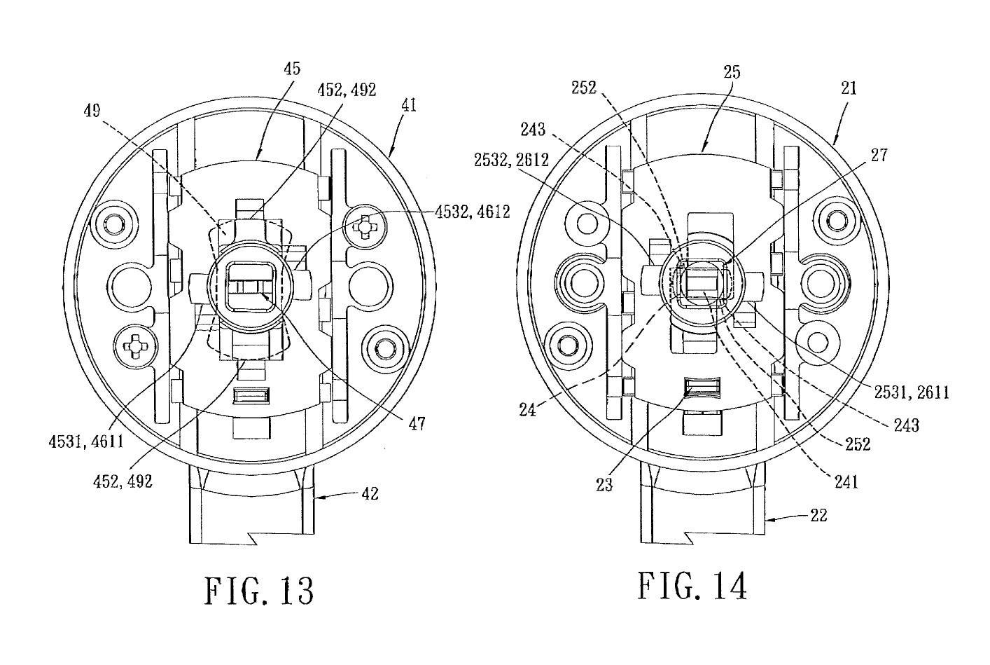

The door lock assembly, which is in a locking position as shown in FIGS. 13, 14 can be operated. to change to an unlocking position (FIGS. 4, 5, 6) by turning the turning knob 24, by operating the key-operated lock 44 using a key, or by pushing or pulling the inner handle 22. The operation of the inner handle 22 will drive a sliding movement of the slide plate 25 through the actuator 23, causing one of the edge parts 252 of the slide plate 25 to push one of the abutment surfaces 243 of the end piece 241 to rotate the turning knob 24. This results in rotation of the transmission shaft 47 and the limit plate 49 to permit the sliding movement of the slide plate 45 for rotation of the rotary cam 46. At the same time, the slide plate 25 will rotate the rotary cam 26 and the spindle tube 27, moving the latch 62 to its retracted position.

Referring again to FIGS. 13 and 14, when a door is locked by the door lock assembly of the present invention, the stop edges 492 of the limit plate 49 respectively abut the flanged parts 452 of the slide plate 45. Therefore, the slide plate 45 is prevented from movements In these situations, if the outer handle 42 is rotated by a pushing or pulling action, because the strip of the actuator 43 is resiliently flexible and can deform resiliently, no damage will occur in the assembly of the outer handle 42, the actuator 43 and the slide plate 45.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A door lock assembly comprising an inner lock unit which includes:
an inner housing;
a rotary cam mounted rotatably within said inner housing and having a driven element;
a spindle tube extending through and rotating along with said rotary cam about a rotation axis;
an inner handle connected movably to said inner housing to pivot about a pivot axis transverse to the rotation axis;
a slide plate mounted movably within said inner housing to slide transversely of the rotation axis, and having a drive element;
an actuator having one end connected to said inner handle, and another end connected to said slide plate, said actuator being moved by said inner handle to actuate a sliding movement of said slide plate; and
a latch unit connected to and driven by said spindle tube, said latch unit moving to a retracted position from an extended position when said drive element drives said driven element.

2. The door lock assembly of claim 1, wherein said actuator is a strip having two ends connected respectively to said inner handle and said slide plate.

3. The door lock assembly of claim 2, wherein said inner handle has a pivot part pivoted to said inner housing handle has a pivot part pivoted to said inner housing and having said pivot axis, one of said two ends of said strip being connected to said pivot part, said strip and said inner handle rotating simultaneously about said pivot axis when said inner handle is pushed or pulled.

4. The door lock assembly of claim 2, wherein said strip is resiliently flexible.

5. The door lock assembly of claim 1, wherein said inner housing has an inner surface that is transverse to the rotation axis of said spindle tube and that is formed with a slide channel receiving said slide plate.

6. The door lock assembly of claim 2, wherein said slide plate has an engaging hole, and said strip is engaged in said engaging hole.

7. The door lock assembly of claim 1, wherein said rotary cam has a rectangular central hole for extension of said spindle tube, said driven elements project radially from said rotary cam, said drive elements projects axially from said slide plate to contact said driven elements, respectively.

8. The door lock assembly of claim 1, further comprising a turning knob disposed within said inner housing to rotate about the rotation axis of said spindle tube, and including an operating outer end exposed from said inner housing, and an interior end extending to said slide plate, said slide plate further having an interaction member to interact with said interior end of said turning knob to control rotation of said turning knob.

9. The door lock assembly of claim 8, wherein said slide plate further has a middle hole to receive said interior end, and an inner peripheral edge bounding said middle hole, said interaction member being formed at said inner peripheral edge.

10. The door lock assembly of claim 9, wherein said interior end of said turning knob has an end face abutting against said slide plate, and an end piece that protrudes from said end face into said middle hole and that has two opposite abutment surfaces to interact with said interaction member of said slide plate.

11. The door lock assembly of claim 10, wherein said interaction member includes two opposite edge parts of said inner peripheral edge to respectively abut said abutment surfaces of said end piece, said end piece being rotated when one of said edge parts pushes one of said abutment surfaces.

12. A door lock assembly of claim 10, wherein said end piece is centered at the rotation axis of said spindle tube and is elongated in a diametric direction, said end piece having two opposite long sides in the diametric direction and two opposite short sides interconnecting said long sides, one of said abutment surfaces being disposed on one of said long sides adjacent to one of said short sides, the other one of said abutment surfaces being disposed on the other one of said long sides adjacent to the other one of said short sides, said end piece being rotated when one of said edge parts pushes one of said abutment surfaces.

13. The door lock assembly of claim 8, wherein said inner housing includes a cap portion receiving said slide plate and said rotary cam, and an extension portion protruding from an outer side of said cap portion and spatially communicated with said cap portion, said inner handle being pivoted to said extension portion, said strip of said actuator and said turning knob being disposed within said extension portion.

14. The door lock assembly of claim 1, further comprising an outer lock unit which includes:
an outer housing;
a rotary cam mounted rotatably within said outer housing and having two angularly spaced apart driven elements;
an outer handle connected movably to said outer housing;
a slide plate mounted movably within said outer housing to slide transversely of a rotation axis of said rotary cam of said outer lock unit, and having, two drive elements;
an actuator having one end connected to said outer handle, and another end connected to said slide plate of said outer lock unit, said actuator being moved by said outer handle to actuate a sliding movement of said slide plate of said outer lock unit;
a key-operated lock disposed within said outer housing and having a plug;
a transmission shaft connected to said plug and extending through said rotary cams of said inner and outer lock units and said spindle tube; and
a limit plate having a passage hole for passage of said transmission shaft, and disposed adjacent said slide plate of said outer lock unit;
said spindle tube extending through said latch unit and into said rotary cam of said outer lock unit so that said latch unit can be moved to the retracted position when said outer handle is pushed/pulled to actuate the sliding movement of said slide plate of said outer lock unit;
said limit plate preventing said slide plate of said outer lock from moving when said key-operated lock is in a locking position.

15. A door lock assembly comprising:
an outer housing;
a rotary cam mounted rotatably within said outer housing and having two angularly spaced apart driven elements;
a spindle tube extending through and rotating along with said rotary cam about a rotation axis;
an outer handle connected movably to said outer housing to pivot about a pivot axis transverse to the rotation axis;
a slide plate mounted movably within said outer housing to slide transversely of the rotation axis, and having two drive elements;
an actuator having one end connected to said outer handle, and another end connected to said slide plate, said actuator being moved by said outer handle to actuate a sliding movement of said slide plate;
a latch unit connected to and driven by said spindle tube to move from an extended position to a retracted position;
a key-operated lock disposed within said outer housing and having a plug;
a transmission shaft connected to said plug and extending through said rotary cam and said spindle tube; and
a limit plate having a passage hole for passage of said transmission shaft, and disposed adjacent said slide plate to prevent said slide plate from moving when said key-operated lock is in a locking position.

16. The door lock of claim 15, wherein said slide plate is disposed between said rotary cam and said limit plate, said drive elements projecting axially from one side of said slide plate to said rotary cam, said slide plate further having a middle hole, an inner peripheral edge bounding said middle hole, and two opposite flanged parts projecting from said inner peripheral edge to said limit plate, said limit plate having two opposite stop edges to respectively engage said flanged parts when said key operated lock is in the locking position, said transmission shaft extending through said middle hole.

17. A door lock assembly, comprising:
a latch unit including a latch housing, and a latch disposed in said latch housing and movable between an extended position and a retracted position, said latch housing having a pair of latch mounting holes; and
an outer lock unit to operate said latch unit, including an outer housing, an outer cover plate to cover said outer housing, and an outer handle connected pivotally to said outer housing, said outer cover plate incorporating a pair of spaced apart first mounting posts and a pair of spaced apart second mounting posts for connection with said latch unit;
wherein said outer handle is placed in a first position when said first mounting posts extend respectively through said latch mounting holes and in a second position when said second mounting posts extend respectively through said latch mounting holes, and said first and second positions are distant from each other by a predetermined angle.

18. The door lock assembly of claim 17, wherein said first and second positions are distant from each other by 90 degrees.

19. The door lock assembly of claim 17, further comprising a pair of screw rods, and an inner lock unit to operate said latch unit, said inner lock unit including an inner housing that has a pair of mounting post connecting holes, each of said screw rods passing through one of said mounting post connecting holes of said inner housing and connected threadedly to one of said second mounting posts when said outer handle is placed in said first or second position.

20. The door lock assembly of claim 17, wherein each of said first mounting posts is spaced apart angularly from one of said second mounting posts by an angle of about 90 degrees.
